(19) United States
(12) Patent Application Publication
(10) Pub. No.: US 2024/0177952 A1
(43) Pub. Date: May 30, 2024

(54) ELECTRIC CIRCUIT BREAKER DEVICE

(71) Applicant: DAICEL CORPORATION, Osaka-shi, Osaka (JP)

(72) Inventor: Tomohide FUJIWARA, Tokyo (JP)

(73) Assignee: DAICEL CORPORATION, Osaka-shi, Osaka (JP)

(21) Appl. No.: 18/285,126

(22) PCT Filed: Feb. 9, 2022
(86) PCT No.: PCT/JP2022/005047

§ 371 Date: Sep. 29, 2023

(30) Foreign Application Priority Data
Mar. 30, 2021 (JP) 2021-057903

(51) Int. Cl. H01H 39/00

(52) U.S. Cl. CPC H01H 39/006; H01H 2039/008

(57) ABSTRACT

An electric circuit breaker includes an igniter provided in a housing, a projectile configured to be projected by energy received from the igniter and move along an extension direction of an accommodating space, and a conductor including a cutoff portion disposed crossing the accommodating space between a first connecting end portion and a second connecting end portion and configured to be cut off by the movement of the projectile. The projectile includes a rod portion, the rod portion includes a widened portion having a cross-sectional area orthogonal to an axial direction of the rod portion increasing from a tip end side toward a rear end side in the axial direction, and the widened portion includes an interference fit portion that is interference-fitted by coming into contact with the inner wall of the housing defining a the holding region of the conductor when the projectile is projected.

### TECHNICAL FIELD

The present invention relates to an electric circuit breaker.

### BACKGROUND ART

An electric circuit may be provided with a breaker configured to be actuated and urgently interrupt electrical conduction in an electric circuit when an abnormality occurs in a device constituting the electric circuit or when an abnormality occurs in a system including the electric circuit. As one aspect of the breaker, an electric circuit breaker has been proposed in which an igniter or the like applies energy to a projectile to move the projectile at a high speed and forcibly and physically cut a conductor piece that forms a part of the electric circuit (e.g., see Patent Document 1 and the like). In recent years, an electric circuit breaker applied to an electric vehicle equipped with a high-voltage power supply is becoming increasingly important.

### CITATION LIST

### Patent Documents

Patent Document 1: WO 2020/093079
Patent Document 2: JP 2013-138004 A
Patent Document 3: JP 2017-525114 T

### SUMMARY OF INVENTION

### Technical Problem

In the electric circuit breaker, after cutting the conductor piece, the projectile projected during actuation stops by striking against a part of a housing. However, if the projectile bounces due to the force of striking, the conductor evaporated by arc discharge at the time of cutting is diffused inside the housing, and this may decrease an insulation resistance value after the cutting. This decrease in the insulation resistance value after cutting is desirably suppressed by quickly stopping the projectile after the conductor piece is cut.

The technique of the present disclosure has been made in view of the circumstances described above, and an object thereof is to provide an electric circuit breaker that suppresses a decrease in an insulation resistance value after cutting.

### Solution to Problem

To solve the above problems, an electric circuit breaker of the present disclosure includes a housing serving as an outer shell member and including an accommodating space extending in one direction, an igniter provided in the housing, a projectile disposed in the housing and configured to be projected from an end side of the accommodating space by energy received from the igniter and move along an extension direction of the accommodating space, and a conductor piece held by the housing and forming a part of an electric circuit, the conductor piece including a cutoff portion disposed crossing the accommodating space between a first connecting end portion and a second connecting end portion and configured to be cut off by movement of the projectile. In the accommodating space, a region defined by an inner wall of the housing holding the conductor piece serves as a holding region, the projectile includes a rod portion extending along the extension direction of the accommodating space and inserted into the holding region, the rod portion includes a widened portion having a cross-sectional area orthogonal to an axial direction of the rod portion increasing from a tip end side toward a rear end side in the axial direction, and the widened portion includes an interference fit portion that is interference-fitted by coming into contact with the inner wall of the housing defining the holding region when the projectile is projected.

The projectile may include a piston portion connected to a rear end side of the rod portion and formed having a cross-sectional area orthogonal to the axial direction larger than a cross-sectional area on the rear end side of the rod portion and a cross-sectional area of the holding region, the housing may include a housing body including the holding region, and the piston portion may be moved by actuation of the igniter, and the interference fit portion may be interference-fitted at a position where the piston portion strikes against a part of the housing body.

The housing may include a projectile initial arrangement region at one end of the accommodating space and an arc-extinguishing region at the other end of the accommodating space, and when the piston portion is moved by the actuation of the igniter, the piston portion may push gas on a side of the projectile initial arrangement region toward a side of the arc-extinguishing region, thereby guiding arc generated at the time of cutting off of the cutoff portion toward the arc-extinguishing region.

The rod portion may have a substantially cylindrical shape in which an outer shape of a transverse cross section is a circular shape, and the widened portion may have a tapered shape with a diameter gradually increasing from the tip end side toward the rear end side in the axial direction.

The holding region may be formed as a cylindrical space having a constant diameter along an extension direction of the holding region, and the diameter of the holding region may be larger than a diameter of the tip end portion of the widened portion and smaller than a diameter of the rear end portion of the widened portion.

The interference fit portion may include a first interference fit portion and a second interference fit portion disposed rearward of the first interference fit portion in the axial direction of the rod portion, and a diameter increase rate at which the second interference fit portion increases in diameter from the tip end side toward the rear end side in the axial direction of the rod portion may be larger than a diameter increase rate at which the first interference fit portion increases in diameter from the tip end side toward the rear end side in the axial direction of the rod portion.

The projectile further may include a piston portion connected to the rear end side of the rod portion and having a diameter larger than a diameter of the rod portion, and the second interference fit portion may be provided at a connecting end portion where the rod portion is connected to the piston portion.

### Advantageous Effects of Invention

The present disclosure can provide an electric circuit breaker that suppresses a decrease in an insulation resistance value after actuation.

### BRIEF DESCRIPTION OF DRAWINGS

FIG. 1 is a view illustrating an internal structure of an electric circuit breaker (hereinafter, simply referred to as a “breaker”) according to an embodiment.

FIG. 2 is a top view of a conductor piece according to the embodiment.

FIG. 3 is a cross-sectional view of a projectile.

FIG. 4 is a diagram illustrating an area (cross-sectional area) of a region located inside a contour in a cross section orthogonal to an axial direction of a rod portion.

FIG. 5 is diagrams illustrating actuation situations of the breaker.

FIG. 6 is a diagram illustrating a variation of the projectile.

### DESCRIPTION OF EMBODIMENTS

### First Embodiment

An electric circuit breaker according to an embodiment of the present disclosure will be described below with reference to the drawings. Note that each of the configurations, combinations thereof, and the like in the embodiment are an example, and various additions, omissions, substitutions, and other changes may be made as appropriate without departing from the spirit of the present disclosure. The present disclosure is not limited by the embodiment and is limited only by the claims.

### Configuration

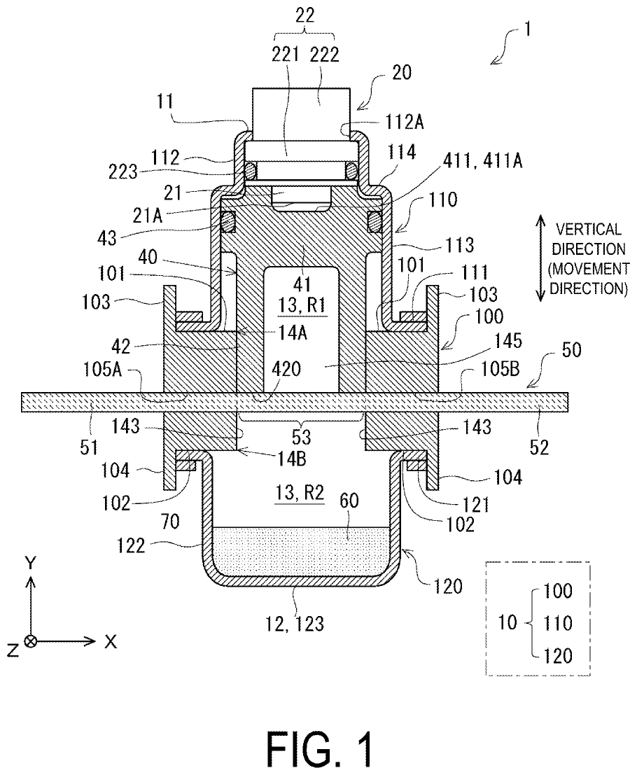

FIG. 1 is a diagram illustrating an internal structure of an electric circuit breaker (hereinafter, simply referred to as a “breaker”) 1 according to an embodiment. The breaker 1 is a device configured to interrupt an electric circuit included in, for example, a vehicle, an electric home appliance, or a photovoltaic system when an abnormality occurs in the electric circuit or in a system including a battery (e.g., a lithium ion battery) of the electric circuit, thereby preventing great damage. In the present specification, a cross section in a height direction illustrated in FIG. 1 (direction in which an accommodating space 13 to be described below extends) is referred to as a longitudinal cross section of the breaker 1, and a cross section in a direction orthogonal to the height direction is referred to as a transverse cross section of the breaker 1. FIG. 1 illustrates a state prior to actuation of the breaker 1.

The breaker 1 includes a housing 10, an igniter 20, a projectile 40, a conductor piece 50, and a coolant material 60. The housing 10 serves as an outer shell member and includes the accommodating space 13 extending in a direction from a first end portion 11 on an upper end side of the housing 10 to a second end portion 12 on a lower end side of the housing 10. The accommodating space 13 is a linear space formed such that the projectile 40 can move through the accommodating space 13 and extends in a vertical direction of the breaker 1. As illustrated in FIG. 1, the projectile 40 is accommodated at an upper end side in the vertical direction (extension direction) of the accommodating space 13 formed inside the housing 10. In the present specification, the vertical direction is also referred to as a Y-axis direction, a left-right direction is also referred to as an X-axis direction, and a depth direction is also referred to as a Z direction. However, in the present specification, the vertical direction and the XYZ directions of the breaker 1 merely indicate the relative positional relationships among the elements in the breaker 1 for convenience of description of the embodiment. For example, the orientation of the breaker 1 when installing the breaker 1 is not limited to the direction illustrated in the drawings.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially prismatic outer shape. However, the shape of the housing body 100 is not particularly limited. The housing body 100 includes a cavity portion 145 that extends through the housing body 100 in the vertical direction. The cavity portion 145 forms a part of the accommodating space 13. The housing body 100 further includes an upper surface 101 to which a flange portion 111 of the top holder 110 is fixed and a lower surface 102 to which a flange portion 121 of the bottom container 120 is fixed. In the present embodiment, an upper cylindrical wall 103 having a cylindrical shape is provided erected upward from the upper surface 101 on the outer peripheral side of the upper surface 101 in the housing body 100. In the present embodiment, the upper cylindrical wall 103 has, for example, a rectangular cylindrical shape, but may have another shape. On the outer peripheral side of the lower surface 102 in the housing body 100, a lower cylindrical wall 104 having a cylindrical shape is suspended from the lower surface 102. In the present embodiment, the lower cylindrical wall 104 has, for example, a rectangular cylindrical shape, but may have another shape. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped cylindrical shape with a hollow inside. The top holder 110 includes a small diameter cylinder portion 112 located on the upper side (first end portion 11 side), a large diameter cylinder portion 113 located on the lower side, a connection portion 114 connecting these portions, and the flange portion 111 extending outward from a lower end of the large diameter cylinder portion 113. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper cylindrical wall 103 in the housing body 100. For example, the flange portion 111 may be integrally fastened to the upper surface 101 in the housing body 100 by using a screw or the like, or may be fixed to the upper surface 101 by a rivet or the like, while being disposed inward of the upper cylindrical wall 103. The top holder 110 may be bonded to the housing body 100 by a sealant being applied between the upper surface 101 of the housing body 100 and a lower surface of the flange portion 111 in the top holder 110. This can increase airtightness of the cylindrical space (part of the accommodating space 13) formed inside the housing 10. Instead of the sealant or in combination with the sealant, an O-ring may be interposed between the upper surface 101 of the housing body 100 and the flange portion 111 of the top holder 110 to increase the airtightness of the cylindrical space.

The cavity portion formed inside the small diameter cylinder portion 112 in the top holder 110 serves as an accommodating space for accommodating a part of the igniter 20, as illustrated in FIG. 1. The cavity portion formed inside the large diameter cylinder portion 113 in the top holder 110 communicates with the cavity portion of the housing body 100 positioned below to form a part of the cylindrical space. The top holder 110 configured as described above can be formed from an appropriate metal member, such as stainless steel or aluminum, having excellent strength and durability. However, the material used for forming the top holder 110 is not particularly limited. Also, in terms of the shape of the top holder 110, the above aspect is merely an example and other shapes may be adopted.

### Bottom Container

Next, the bottom container 120 will be described. The bottom container 120 has a substantially cylindrical bottomed shape with a hollow inside and includes a side wall portion 122, a bottom wall portion 123 connected to a lower end of the side wall portion 122, and a flange portion 121 connected to an upper end of the side wall portion 122. The side wall portion 122 has, for example, a cylindrical shape, and the flange portion 121 extends outward from the upper end of the side wall portion 122. The contour of the flange portion 121 in the bottom container 120 has a substantially quadrangular shape that fits inside the lower cylindrical wall 104 in the housing body 100. For example, the flange portion 121 may be integrally fastened to the lower surface 102 in the housing body 100 by using a screw or the like, or may be fixed to the lower surface 102 by a rivet or the like, while being disposed inward of the lower cylindrical wall 104. The bottom container 120 may be bonded to the housing body 100 by sealant being applied between the lower surface 102 of the housing body 100 and an upper surface of the flange portion 121 in the bottom container 120. This can increase airtightness of the cylindrical space (part of the accommodating space 13) formed in the housing 10. Instead of the sealant or in combination with the sealant, an O-ring may be interposed between the lower surface 102 of the housing body 100 and the flange portion 121 of the bottom container 120 to increase the airtightness of the cylindrical space.

Note that the above aspect regarding the shape of the bottom container 120 is an example and other shapes may be adopted. The cavity portion formed inside the bottom container 120 communicates with the housing body 100 positioned above and forms a part of the cylindrical space. The bottom container 120 configured as described above can be formed from an appropriate metal member, such as stainless steel or aluminum, having excellent strength and durability, for example. However, the material used for forming the bottom container 120 is not particularly limited. The bottom container 120 may further have a multilayer structure. For example, in the bottom container 120, an exterior portion facing the outside may be formed from an appropriate metal member, such as stainless steel or aluminum, having excellent strength and durability, and an interior portion facing the cylindrical space side may be formed from an insulating member such as a synthetic resin. Of course, the entire bottom container 120 may be formed from an insulating member.

As described above, the housing 10 in the embodiment includes the housing body 100, the top holder 110, and the bottom container 120 that are integrally assembled. Further, the cylindrical space extending in the direction from the first end portion 11 to the second end portion 12 is formed inside the housing 10. The cylindrical space accommodates the igniter 20, the projectile 40, a cutoff portion 53 in the conductor piece 50, and the coolant material 60, which will be described below in detail.

### Igniter

Next, the igniter 20 will be described. The igniter 20 is an electric igniter including an ignition portion 21 with an ignition charge and an igniter body 22 with a pair of conductive pins (not illustrated) connected to the ignition portion 21. The igniter body 22 is surrounded by an insulating resin, for example. Tip end sides of the pair of conductive pins in the igniter body 22 are exposed to the outside, and are connected to a power supply when the breaker 1 is used.

The igniter body 22 includes a body portion 221 having a substantially cylindrical shape and being accommodated inside the small diameter cylinder portion 112 in the top holder 110, and a connector portion 222 positioned on top of the body portion 221. The igniter body 22 is fixed to the small diameter cylinder portion 112 by, for example, the body portion 221 being press-fitted into an inner peripheral surface of the small diameter cylinder portion 112. A constricted portion having an outer peripheral surface recessed as compared with other locations is annularly formed along a circumferential direction of the body portion 221 at an axially intermediate portion of the body portion 221, and an O-ring 223 is fitted into the constricted portion. The O-ring 223 is formed from, for example, rubber (e.g., silicone rubber) or a synthetic resin, and serves to increase airtightness between the inner peripheral surface in the small diameter cylinder portion 112 and the body portion 221.

The connector portion 222 in the igniter 20 is disposed protruding to the outside through an opening 112A formed in an upper end of the small diameter cylinder portion 112. The connector portion 222 has, for example, a cylindrical shape covering a side of the conductive pin, allowing connection with a connector of a power supply.

As illustrated in FIG. 1, the ignition portion 21 of the igniter 20 is disposed facing the accommodating space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of conductive pins to each other. For the ignition charge, zirconium potassium perchlorate (ZPP), zirconium tungsten potassium perchlorate (ZWPP), titanium hydride potassium perchlorate (THPP), lead tricinate, or the like may be used.

In actuation of the igniter 20, an actuating current for igniting the ignition charge is supplied from the power supply to the conductive pins which causes the bridge wire in the ignition portion 21 to generate heat. As a result, the ignition charge in the igniter cup is ignited and burns, generating a combustion gas. Then, the combustion of the ignition charge in the igniter cup of the ignition portion 21 causes the pressure in the igniter cup to increase, a rupture surface 21A of the igniter cup ruptures, and the combustion gas is discharged from the igniter cup into the accommodating space 13. More specifically, the combustion gas from the igniter cup is discharged into a recess 411 formed in a piston portion 41 (described below) of the projectile 40 disposed in the accommodating space 13. Thus, the projectile 40 is projected downward from an initial position illustrated in FIG. 1 along the accommodating space 13.

### Conductor Piece

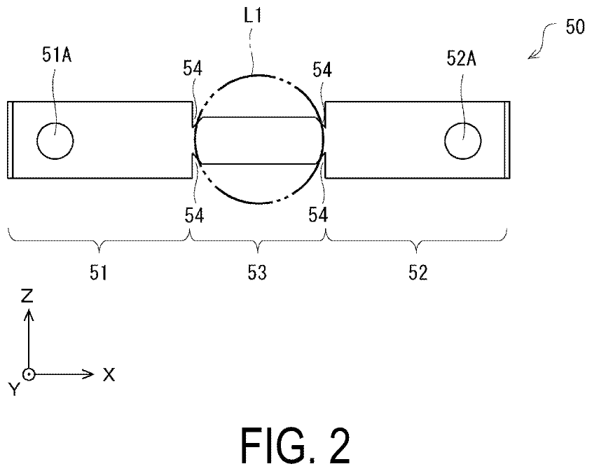

Next, the conductor piece 50 will be described. FIG. 2 is a top view of the conductor piece 50 according to the embodiment. The conductor piece 50 is a conductive metal body that constitutes some of the components of the breaker 1 and, when the breaker 1 is attached to a predetermined electric circuit, forms a part of the electric circuit. The conductor piece 50 may be referred to as a bus bar. The conductor piece 50 is held by the housing body 100 and is disposed crossing the cavity portion 145 in the housing body. In the present embodiment, a region (cavity portion 145) defined by an inner wall of the housing body 100 holding the conductor piece 50 in this way serves as a holding region.

The conductor piece 50 can be formed from a metal such as copper (Cu), for example. However, the conductor piece 50 may be formed from a metal other than copper, or may be formed from an alloy of copper and another metal. Note that examples of metals other than copper included in the conductor piece 50 include manganese (Mn), nickel (Ni), and platinum (Pt).

In one aspect illustrated in FIG. 2, the conductor piece 50 is formed as an entirely elongated flat plate piece and includes a first connecting end portion 51 and a second connecting end portion 52 on either end, and the cutoff portion 53 positioned in an intermediate portion between the first connecting end portion 51 and the second connecting end portion 52. Connection holes 51A and 52A are formed in the first connecting end portion 51 and the second connecting end portion 52 of the conductor piece 50, respectively. These connection holes 51A and 52A are used for connection with other conductors (e.g., lead wires) in the electric circuit. Note that in FIG. 1, the connection holes 51A and 52A in the conductor piece 50 are not illustrated. The cutoff portion 53 of the conductor piece 50 is a portion that is forcibly and physically cut by a rod portion 42 of the projectile 40 and is cut off from the first connecting end portion 51 and the second connecting end portion 52 when an abnormality such as excessive current occurs in the electric circuit to which the breaker 1 is applied. Notches (slits) 54 are formed at both ends of the cutoff portion 53 of the conductor piece 50, making it easy to cut and cut off the cutoff portion 53.

The conductor piece 50 is cut at a position overlapping an inner surface (inner wall surface) of an inner wall 143 (FIG. 1) defining the cavity portion 145 of the housing body 100, that is, at a position overlapping the outer peripheral surface of the rod portion 42, so that the cutoff portion 53 is cut off.

The conductor piece 50 can have various forms, and the shape of the conductor piece 50 is not particularly limited. While, in the example illustrated in FIG. 2, surfaces of the first connecting end portion 51, the second connecting end portion 52, and the cutoff portion 53 form the same surface, the configuration is not limited thereto. For example, in the conductor piece 50, the cutoff portion 53 may be connected to the first connecting end portion 51 and the second connecting end portion 52 in an orthogonal or inclined orientation. The planar shape of the cutoff portion 53 of the conductor piece 50 is not particularly limited, either. Of course, the shapes of the first connecting end portion 51 and the second connecting end portion 52 of the conductor piece 50 are not particularly limited, either. The notches 54 in the conductor piece 50 can be omitted as appropriate.

### Coolant Material

Next, the coolant material 60 disposed in the accommodating space 13 in the housing 10 will be described. As illustrated in FIG. 1, prior to actuation of the breaker 1 (igniter 20), the cutoff portion 53 of the conductor piece 50 in a state of being held in a pair of conductor piece holding holes 105A and 105B in the housing body 100 is horizontally laid across the accommodating space 13 of the housing 10. Hereinafter, within the accommodating space 13 of the housing separated by the cutoff portion 53 of the conductor piece 50, a region (space) in which the projectile 40 is disposed is referred to as a “projectile initial arrangement region R1”, and a region (space) positioned on the opposite side of the projectile 40 is referred to as an “arc-extinguishing region R2”. Note that, as described above, since a gap is formed on the side of the cutoff portion 53 disposed crossing the accommodating space 13, the projectile initial arrangement region R1 and the arc-extinguishing region R2 are not completely isolated from each other by the cutoff portion 53 and communicate with each other. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodating space 13 is a region (space) for receiving the cutoff portion 53 cut off by the rod portion 42 of the projectile 40 projected during actuation of the breaker 1 (igniter 20). The coolant material 60 serving as an arc-extinguishing material is disposed in this arc-extinguishing region R2. The coolant material 60 is a coolant material for removing thermal energy of the cutoff portion 53 and the arc generated when the projectile 40 cuts off the cutoff portion 53 of the conductor piece 50, and cools the arc and the cutoff portion 53, thereby suppressing arc generation during cut off of a current or thereby extinguishing (eliminating) the generated arc.

The arc-extinguishing region R2 of the breaker 1 has significance as a space for receiving the cutoff portion 53 cut off from the first connecting end portion 51 and the second connecting end portion 52 of the conductor piece 50 by the projectile 40 and, at the same time, as a space for effectively extinguishing the arc generated when the projectile 40 cuts off the cutoff portion 53. Then, to effectively extinguish the arc generated when the cutoff portion 53 is cut off from the conductor piece 50, the coolant material 60 is disposed as an arc-extinguishing material in the arc-extinguishing region R2.

As one aspect of the embodiment, the coolant material 60 is solid. As one aspect of the embodiment, the coolant material 60 is formed from a shape retaining body. The shape retaining body herein is, for example, a material that can maintain a constant shape when no external force is applied and can maintain integrity (does not come apart) even when deformation may occur when an external force is applied. For example, examples of the shape retaining body include a fibrous body formed into a desired shape. In the present embodiment, the coolant material 60 is formed from a metal fiber that is a shape retaining body. Examples of the metal fiber forming the coolant material 60 include an aspect including at least any one of steel wool or copper wool. However, the above aspects in the coolant material 60 are examples, and the coolant material 60 is not limited to the above aspects.

The coolant material 60 is formed into a substantially disk shape, for example, and is disposed at a bottom portion of the bottom container 120.

### Projectile

Next, the projectile 40 will be described. The projectile 40 is formed from an insulating member such as synthetic resin, for example, and includes the piston portion 41 and the rod portion 42 connected to the piston portion 41. The piston portion 41 has a substantially cylindrical shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The piston portion 41 has an outer diameter larger than the diameter of the cavity portion 145 in the housing body 100, and is configured to not enter the cavity portion 145 but to strike against a peripheral member forming the cavity portion 145. That is, the piston portion 41 is formed with a cross-sectional area orthogonal to the movement direction (axial direction) on the tip end side connected to the rod portion 42 being larger than the cross-sectional area on the rear end side of the rod portion 42 and the cross-sectional area of the cavity portion 145. The shape of the projectile 40 can be changed as appropriate according to the shape of the housing 10 and the like.

The recess 411 having a cylindrical shape, for example, is formed on an upper surface of the piston portion 41 and receives the ignition portion 21. A bottom surface of the recess 411 is formed as a pressure-receiving surface 411A that receives energy from the igniter 20 during actuation of the igniter 20. A constricted portion having an outer peripheral surface recessed as compared with other locations is annularly formed along a circumferential direction of the piston portion 41 at an axially intermediate portion of the piston portion 41, and an O-ring 43 is fitted into the constricted portion. The O-ring 43 is formed from, for example, rubber (e.g., silicone rubber) or a synthetic resin, and serves to increase airtightness between an inner peripheral surface in the large diameter cylinder portion 113 and the piston portion 41.

The rod portion 42 of the projectile 40 is a rod-shaped member having an outer peripheral surface smaller in diameter than the piston portion 41, for example, and extending in the extension direction of the accommodating space 13, and is integrally connected to a lower end side of the piston portion 41. When the igniter 20 is actuated, the rod portion 42 moves along the extension direction of the accommodating space 13 and is inserted into the cavity portion 145 of the housing body 100. A lower end surface of the rod portion 42 is formed as a cutoff surface 420 used when cutting off the cutoff portion 53 from the conductor piece 50 during actuation of the breaker 1. Note that, although the rod portion 42 in the present embodiment has a substantially cylindrical shape, the shape of the rod portion 42 is not particularly limited, and can be changed in accordance with the shape and size of the cutoff portion 53 to be cut off from the conductor piece 50 during actuation of the breaker 1. The rod portion 42 may have a columnar shape such as a cylinder, an elliptic cylinder, or a prism, for example. Note that, at the initial position of the projectile 40 illustrated in FIG. 1, a region of the rod portion 42 of the projectile 40 on a tip end side including the cutoff surface 420 is located above the cavity portion (holding region) 145 of the housing body 100.

The projectile 40 configured as described above is projected from the initial position illustrated in FIG. 1 when the upper surface of the piston portion 41 including the pressure-receiving surface 411A receives energy from the igniter 20 during actuation of the igniter 20, and moves at a high speed toward the second end portion 12 side (downward) along the accommodating space 13. Specifically, as illustrated in FIG. 1, the piston portion 41 of the projectile 40 is accommodated inside the large diameter cylinder portion 113 in the top holder 110, and is slidable in the axial direction along an inner wall surface of the large diameter cylinder portion 113. The projectile 40 after being projected stops when the lower end surface of the piston portion 41 abuts (collides) against the upper surface 101 of the housing body 100. That is, the rod portion 42 is fitted into the cavity portion 145 up to a rear end 421. In the present embodiment, the piston portion 41 of the projectile 40 has a substantially cylindrical shape, but the shape of the piston portion 41 is not particularly limited. As the outer shape of the piston portion 41, an appropriate shape and size can be adopted in accordance with the shape and size of the inner wall surface of the large diameter cylinder portion 113.

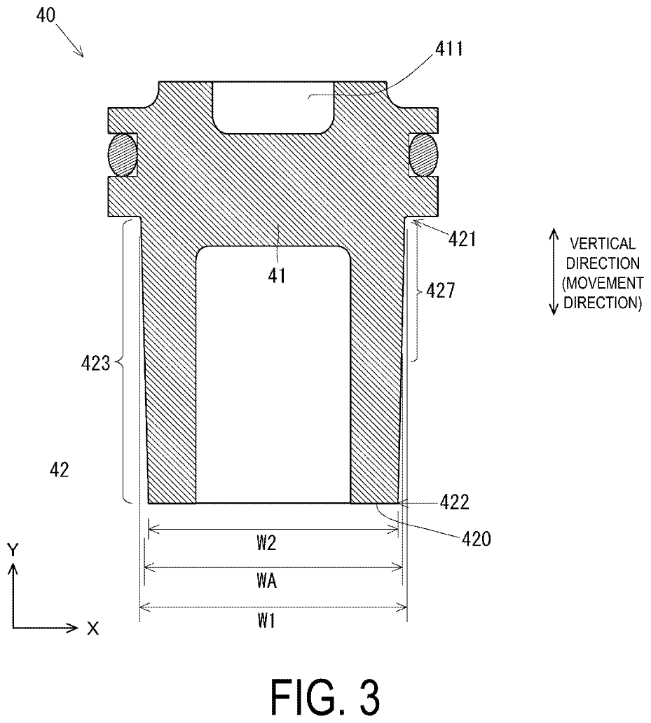

FIG. 3 is a longitudinal cross-sectional view (XY cross-sectional view) of the projectile 40. As illustrated in FIG. 3, in the rod portion 42 of the projectile 40, a width W1 of the rear end 421 is wider than a width W2 of a tip end 422 in an orthogonal direction (X direction) orthogonal to the movement direction (axial direction). The rod portion 42 in FIG. 3 has a diameter that uniformly increases from the tip end 422 to the rear end 421, and the entire region from the tip end 422 to the rear end 421 in the movement direction is a widened portion 423. The widened portion 423 has, for example, a tapered shape whose diameter gradually increases from the tip end side toward the rear end side in the movement direction (downward direction along the Y-axis). Note that the rod portion 42 is not limited to a shape whose diameter uniformly increases from the tip end 422 to the rear end 421. That is, the rod portion 42 may be widened only in a partial section in the movement direction and this section may be defined as the widened portion.

In addition, the width W1 of the rear end 421 of the rod portion 42 is formed larger than a width WA in the direction (X direction) of the cavity portion 145 defined by the inner wall of the housing body 100. The width W2 of the tip end 422 is formed smaller than the width WA of the cavity portion 145. That is, W2<WA<W1.

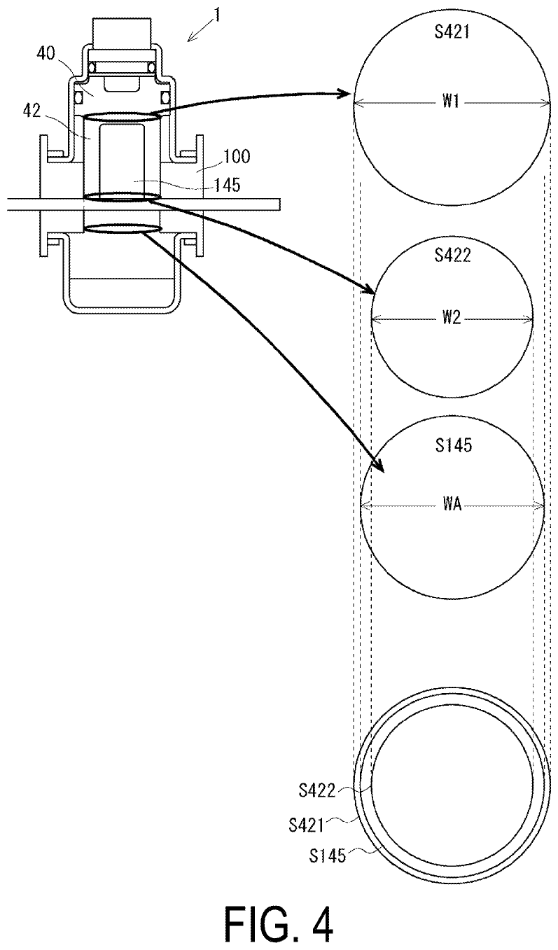

FIG. 4 is a view illustrating an area (cross-sectional area) of a region located inside the contour in a cross section orthogonal to the axial direction of the rod portion 42. The rod portion 42 has a substantially cylindrical shape in which an outer shape of a transverse cross section (XZ section) is a circular shape. Note that, in the present embodiment, the substantially cylindrical shape may be a shape in which the cross-sectional area gradually decreases or gradually increases in the axial direction, provided that the outer shape of the transverse cross section is circular. For example, the rod portion 42 of the present embodiment includes the widened portion 423 whose cross-sectional area gradually increases from the tip end side toward the rear end side and has a truncated cone shape. A circle S421 illustrated in FIG. 4 represents the contour of the rear end 421 in a plane (XZ plane) orthogonal to the movement direction of the rod portion 42, and the area of the inner region of the circle S421 is the cross-sectional area of the rear end 421. A circle S422 represents the contour of the tip end 422 in the plane (XZ plane) orthogonal to the movement direction of the rod portion 42, and the area of the inner region of the circle S422 is the cross-sectional area of the tip end 422. Note that the rod portion 42 of the present embodiment has a cylindrical shape with a cavity: however, regardless of the presence or absence of the cavity, the cross-sectional area of the rod portion 42 in the present embodiment is the area of the contour in the transverse cross section (XZ plane) of the rod portion 42, that is, the area of the entire region located inside the contour. As illustrated in FIG. 4, the rod portion 42 includes the widened portion 423 in which the cross-sectional area orthogonal to the axial direction of the rod portion 42 increases from the tip end side toward the rear end side in the axial direction.

A circle S145 illustrated in FIG. 4 represents the contour of the cavity portion 145 in the plane (XZ plane) orthogonal to the movement direction of the rod portion 42, and the area of the circle S145 is the cross-sectional area of the cavity portion 145. The cavity portion 145 of the housing body 100 is formed as a cylindrical space having a constant width (diameter) WA along the extension direction of the cavity portion 145.

The widened portion 423 of the rod portion 42 includes, at least in part, an interference fit portion 427 formed having a width wider than the width WA of the cavity portion 145. In other words, as illustrated in FIG. 4, the widened portion 423 includes, at least in part, the interference fit portion 427 formed having a larger cross-sectional area orthogonal to the axial direction than the cross-sectional area of the cavity portion 145. Note that in FIG. 4, the sizes of the circles S421, S422, and S145 are exaggerated for convenience of explanation. The size of the rod portion 42 and the size of the cavity portion 145 are not particularly limited: however, in the present embodiment, W1 is 30.5 mm, W2 is 30.2 mm, and WA is 30.4 mm. The ratio between the rear end 421 and the tip end 422 of the rod portion 42 may be, for example, W2/W1=0.993 to 0.987. The difference between the rear end 421 and the tip end 422 of the rod portion 42 may be, for example, W1−W2=0.3 to 0.5 mm. In addition, the ratio between the width WA of the cavity portion 145 and the width W1 of the rear end 421 may be, for example, W1/WA=1.001 to 1.005, or the difference between the width WA of the cavity portion 145 and the width W1 of the rear end 421 may be, for example, W1−WA=0.1 mm.

Since the rod portion 42 includes, at least in part, the interference fit portion 427 having a width larger than the width of the cavity portion 145 as described above, when the rod portion 42 is inserted into the cavity portion 145 by actuation of the igniter 20, the outer peripheral surface of the rod portion 42 comes into contact with the inner wall of the housing body 100, so that the interference fit portion 427 is interference-fitted into the cavity portion 145.

### Operation

Next, operation when the breaker 1 is actuated to interrupt the electric circuit will be described. As described above, FIG. 1 illustrates a state of the breaker 1 prior to actuation (hereinafter, also referred to as a “pre-actuation initial state”). In the pre-actuation initial state, in the projectile 40 of the breaker 1, the piston portion 41 is positioned on the first end portion 11 side (upper end side) in the accommodating space 13, and the cutoff surface 420 formed at the lower end of the rod portion 42 is set at an initial position positioned on the upper surface of the cutoff portion 53 in the conductor piece 50.

Additionally, the breaker 1 according to the embodiment further includes an abnormality detection sensor (not illustrated) configured to detect an abnormal state of a device (such as a vehicle, a power generation facility, or a power storage facility) to which an electric circuit to be interrupted is connected, and a control unit (not illustrated) configured to control the actuation of the igniter 20. In addition to the current flowing through the conductor piece 50, the abnormality detection sensor may be able to detect an abnormal state on the basis of a voltage or a temperature of the conductor piece 50. Further, the abnormality detection sensor may be, for example, an impact sensor, a temperature sensor, an acceleration sensor, or a vibration sensor, and may detect an abnormal state such as an accident or fire on the basis of an impact, a temperature, acceleration, or vibration in a device such as a vehicle. The control unit of the breaker 1 is a computer capable of performing a predetermined function by executing a predetermined control program, for example. The predetermined function of the control unit may be implemented by corresponding hardware. Then, when an excessive current flows through the conductor piece 50 forming a part of the electric circuit to which the breaker 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the conductive pin of the igniter 20 and actuates the igniter 20 on the basis of a current value detected by the abnormality detection sensor. The abnormal current may be a current value that exceeds a predetermined threshold value set for protecting a predetermined electric circuit. Note that the abnormality detection sensor and the control unit described above may not be included in the components of the breaker 1, or may be included in a device separate from the breaker 1, for example. Further, the abnormality detection sensor and the control unit are not essential components of the breaker 1.

For example, when an abnormal current in the electric circuit is detected by an abnormality detection sensor that detects an abnormal current in an electric circuit, the control unit of the breaker 1 actuates the igniter 20. That is, an actuating current is supplied from an external power supply (not illustrated) to the conductive pin of the igniter 20, and as a result, the ignition charge in the ignition portion 21 is ignited and burns, generating a combustion gas. Then, the rupture surface 21A ruptures due to a rise in pressure in the ignition portion 21, and the combustion gas of the ignition charge is discharged from the inside of the ignition portion 21 to the accommodating space 13.

The ignition portion 21 of the igniter 20 is received in the recess 411 of the piston portion 41, and the rupture surface 21A of the ignition portion 21 is disposed facing the pressure-receiving surface 411A of the recess 411 in the projectile 40. Therefore, the combustion gas from the ignition portion 21 is discharged to the recess 411, and the pressure (combustion energy) of the combustion gas is transmitted to the upper surface of the piston portion 41 including the pressure-receiving surface 411A. As a result, the projectile 40 moves downward in the accommodating space 13 in the extension direction (axial direction) of the accommodating space 13.

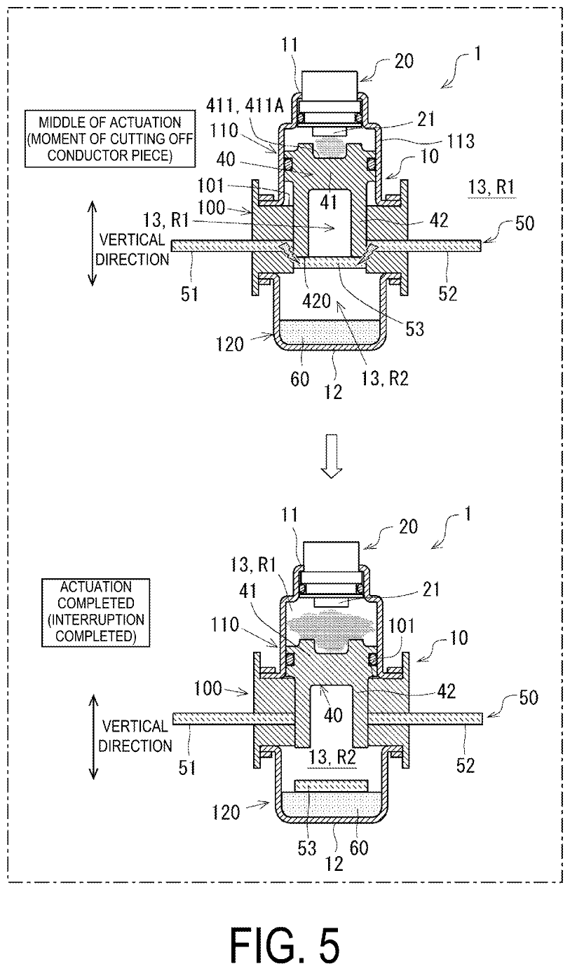

FIG. 5 is diagrams illustrating actuation situations of the breaker 1 according to the embodiment. The upper half of FIG. 5 illustrates a situation in the middle of actuation of the breaker 1, and the lower half of FIG. 5 illustrates a situation in which the actuation of the breaker 1 is complete. As described above, upon actuation of the igniter 20, the projectile 40 having received the pressure (combustion energy) of the combustion gas of the ignition charge is vigorously pushed downward, and as a result, the cutoff surface 420 formed on the lower end side of the rod portion 42 presses and cuts, by shearing, boundary portions between the first connecting end portion 51 and the cutoff portion 53 and between the second connecting end portion 52 and the cutoff portion 53 in the conductor piece 50. As a result, the cutoff portion 53 is cut off from the conductor piece 50. Note that, as long as the projectile 40 can move smoothly in the extension direction (axial direction) of the accommodating space 13 when the igniter 20 is actuated, the shape and dimensions of the projectile 40 can be freely determined. For example, the outer diameter of the piston portion 41 of the projectile 40 may be set to a dimension equal to the inner diameter of the large diameter cylinder portion 113 in the top holder 110.

As illustrated in the lower half of FIG. 5, the projectile 40 moves downward in the extension direction (axial direction) of the accommodating space 13 by a predetermined stroke until the lower end surface of the piston portion 41 abuts against (collides with) the upper surface 101 of the housing body 100. In this state, the cutoff portion 53, which has been cut off from the conductor piece 50 by the rod portion 42 of the projectile 40, is received in the arc-extinguishing region R2 where the coolant material 60 is disposed. As a result, the first connecting end portion 51 and the second connecting end portion 52 located at either end of the conductor piece 50 are electrically disconnected, and the predetermined electric circuit to which the breaker 1 is applied is forcibly interrupted. Note that, when the cutoff portion 53 is cut off from the conductor piece 50 by the rod portion 42, an arc is likely to occur between the cutoff portion 53 having been cut off and the first and second connecting end portions 51 and 52. However, even when an arc occurs, the coolant material 60 removes the thermal energy of the arc and the cutoff portion 53 to cool the arc and the cutoff portion 53, thereby quickly extinguishing the arc and suppressing influence of the arc. When the projectile 40 is further moved by the actuation of the igniter 20 to cut off the cutoff portion 53, the piston portion 41 pushes the gas on the projectile initial arrangement region R1 side to the arc-extinguishing region R2 side together with the particles of the conductor piece 50 transpired by the arc heat as the piston portion 41 moves in the large diameter cylinder portion 113, thereby guiding the arc to the arc-extinguishing region R2 side to be extinguished by the coolant material 60 or the like.

Since the projectile 40 of the present embodiment includes the interference fit portion 427 that is wider than the accommodating space 13 (cavity portion 145) in a part of the widened portion 423 of the rod portion 42, the rod portion 42 is inserted into the cavity portion 145 by the actuation of the breaker 1 as described above, and the interference fit portion 427 is interference-fitted into the cavity portion 145 in a state where the lower end surface of the piston portion 41 abuts against the upper surface 101 of the housing body 100 and stops. Accordingly, the projectile 40 stops without bouncing after the conductor piece 50 is cut.

### Effects of Embodiment

In the breaker 1 according to the embodiment, after the projectile 40 moves along the accommodating space 13 by actuation and cuts the conductor piece 50, the rod portion 42 of the projectile 40 is inserted into the accommodating space 13 (the cavity portion 145) and stops in a state where the interference fit portion 427 is interference-fitted into the cavity portion 145. Therefore, when the projectile 40 cuts the conductor piece 50, the projectile 40 is prevented from bouncing and diffusing the transpired conductor piece 50 into the accommodating space, so that a decrease in an insulation resistance value after cutting can be suppressed.

### Variation

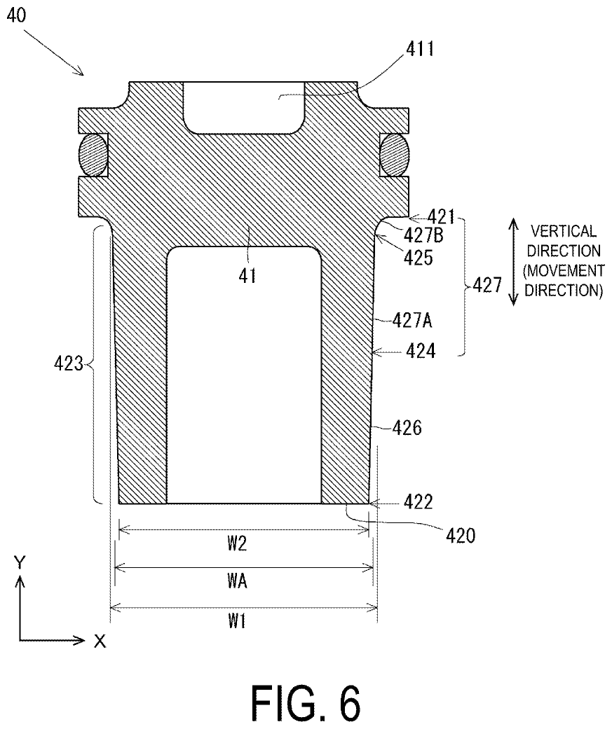

FIG. 6 is a view illustrating a variation of the projectile 40. A projectile of the present variation is different from the projectile 40 described above in that the interference fit portion 427 includes a first interference fit portion 427A and a second interference fit portion 427B. Note that since other portions are the same as those of the embodiment described above, the same elements are denoted by the same reference signs and description thereof will not be repeated.

An intermediate portion 424 illustrated in FIG. 6 is a portion located partway along the movement direction of the rod portion 42, and is a boundary between a tip end side portion 426 and the interference fit portion 427. That is, the projectile 40 is wider than the width WA of the cavity portion 145 on the rear side of the intermediate portion 424 in the movement direction. The first interference fit portion 427A is disposed on the rear side of the intermediate portion 424 as a boundary, and the second interference fit portion 427B is provided on the rear side of the first interference fit portion 427A. The second interference fit portion 427B is provided in the vicinity of a connecting end portion where the rod portion 42 is connected to the piston portion 41.

The first interference fit portion 427A is formed with a width (diameter) increasing from a tip end (intermediate portion 424) side to a rear end 425 side, and for example, the diameter increase rate from the tip end side to the rear end side is set to ΔR1. The second interference fit portion 427B is formed with a width (diameter) increasing from a tip end (the rear end 425 of the first interference fit portion) to a rear end (the rear end 421 of the rod portion) in the axial direction of the rod portion 42, and for example, the diameter increase rate from the tip end side to the rear end side is set to ΔR2. In this case, the diameter increase rate ΔR2 of the second interference fit portion 427B is set larger than the diameter increase rate ΔR1 of the first interference fit portion 427A, and the second interference fit portion 427B has a shape in which the diameter increases sharply.

Thus, in the projectile 40 of the present variation, the first interference fit portion 427A is fitted into the cavity portion 145 and the second interference fit portion 427B is more strongly fitted into the cavity portion 145. Thus, the projectile 40 after being projected is reliably stopped without bouncing. Therefore, according to the present variation, the reliability of suppressing a decrease in an insulation resistance value after cutting is improved.

While an embodiment of the electric circuit breaker according to the present disclosure has been described above, each of the aspects disclosed in the present specification can be combined with any other feature disclosed in the present specification.

### REFERENCE SIGNS LIST

1 Breaker
10 Housing
13 Accommodating space
20 Igniter
40 Projectile
42 Rod portion
423 Widened portion
427 Interference fit portion
427A First interference fit portion
427B Second interference fit portion
50 Conductor piece
53 Cutoff portion
60 Coolant material
145 Cavity portion (holding region)

1. An electric circuit breaker comprising:
a housing serving as an outer shell member and including an accommodating space extending in one direction;
an igniter provided in the housing;
a projectile disposed in the housing and configured to be projected from an end side of the accommodating space by energy received from the igniter and move along an extension direction of the accommodating space; and
a conductor piece held by the housing and forming a part of an electric circuit, the conductor piece including a cutoff portion disposed crossing the accommodating space between a first connecting end portion and a second connecting end portion and configured to be cut off by movement of the projectile, wherein,
in the accommodating space, a region defined by an inner wall of the housing holding the conductor piece serves as a holding region,
the projectile includes a rod portion extending along the extension direction of the accommodating space and inserted into the holding region,
the rod portion includes a widened portion having a cross-sectional area orthogonal to an axial direction of the rod portion increasing from a tip end side toward a rear end side in the axial direction, and
the widened portion includes an interference fit portion that is interference-fitted by coming into contact with the inner wall of the housing defining the holding region when the projectile is projected.

2. The electric circuit breaker according to claim 1, wherein
the projectile includes a piston portion connected to a rear end side of the rod portion and formed having a cross-sectional area orthogonal to the axial direction larger than a cross-sectional area on the rear end side of the rod portion and a cross-sectional area of the holding region,
the housing includes a housing body including the holding region, and
the piston portion is moved by actuation of the igniter, and the interference fit portion is interference-fitted at a position where the piston portion strikes against a part of the housing body.

3. The electric circuit breaker according to claim 2, wherein
the housing includes a projectile initial arrangement region at one end of the accommodating space and an arc-extinguishing region at the other end of the accommodating space, and
when the piston portion is moved by the actuation of the igniter, the piston portion pushes gas on a side of the projectile initial arrangement region toward a side of the arc-extinguishing region, thereby guiding an arc generated at the time of cutting off of the cutoff portion toward the arc-extinguishing region.

4. The electric circuit breaker according to claim 1, wherein
the rod portion has a substantially cylindrical shape in which an outer shape of a transverse cross section is a circular shape, and
the widened portion has a tapered shape with a diameter gradually increasing from the tip end side toward the rear end side in the axial direction.

5. The electric circuit breaker according to claim 4, wherein the holding region is formed as a cylindrical space having a constant diameter along an extension direction of the holding region, and the diameter of the holding region is larger than a diameter of the tip end portion of the widened portion and smaller than a diameter of the rear end portion of the widened portion.

6. The electric circuit breaker according to claim 4, wherein
the interference fit portion includes a first interference fit portion and a second interference fit portion disposed rearward of the first interference fit portion in the axial direction of the rod portion, and
a diameter increase rate at which the second interference fit portion increases in diameter from the tip end side toward the rear end side in the axial direction of the rod portion is larger than a diameter increase rate at which the first interference fit portion increases in diameter from the tip end side toward the rear end side in the axial direction of the rod portion.

7. The electric circuit breaker according to claim 6, wherein
the projectile further includes a piston portion connected to the rear end side of the rod portion and having a diameter larger than a diameter of the rod portion, and
the second interference fit portion is provided at a connecting end portion where the rod portion is connected to the piston portion.
